(19) United States
(12) Patent Application Publication
(10) Pub. No.: US 2014/0103675 A1
(43) Pub. Date: Apr. 17, 2014

(54) CONSTRUCTIBLE SCOOP

(71) Applicant: EcoTensil Inc., Corte Madera, CA (US)

(72) Inventor: Peggy V. K. Cross, Larkspur, CA (US)

(73) Assignee: EcoTensil Inc., Corte Madera, CA (US)

(21) Appl. No.: 14/032,194

(22) Filed: Sep. 19, 2013

Related U.S. Application Data
(60) Provisional application No. 61/712,610, filed on Oct. 11, 2012.

(51) Int. Cl. B25B 9/02

(52) U.S. Cl. CPC B25B 9/02
USPC 294/180

(57) ABSTRACT

A system and method for a constructible scoop that overcomes the disadvantages of conventional preformed scoops that are shipped in association with a scoopable product. A constructible scoop may be protected and provided outside of the product-containing-volume where it is easily located and sealed to be sanitary prior to first use.

### CROSS REFERENCE TO RELATED APPLICATIONS

This application claims benefit of Patent Application 61/712,610 filed 11 Oct. 2013, the contents of which are hereby expressly incorporated by reference thereto in its entirety for all purposes.

### FIELD OF THE INVENTION

The present invention relates generally to utensils, service implements, and devices, and more specifically, but not exclusively, to constructible utensils and implements formed from planar stock.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Products are often delivered in a powdered (or other “scoopable”) format shipped in a container defining a closed cylindrical or rectilinear volume. For consumer products, these products are typically consumed in specific portion sizes. Manufacturers and/or distributors will often aid the consumer in identifying the specific portion sizes by providing a scoop or a measuring cup of the appropriate volume. Sometimes there are different dispensation options with different associated volumes. In which case, the scoop or the measuring cup may be provided with volume-indicating demarcations so the user/consumer is able to measure the appropriate/desired volume of powder. Some users/consumers rely on these shipped scoops for proper use of the material.

When provided, such scoops and measuring cups are frequently not environmentally-friendly being manufactured of plastic and other non-environmentally friendly materials. As users and consumers are increasingly looking for environmentally-friendly products, those scoops and measuring cups are less desirable to the consumer.

A further issue arises that in some contexts is more important. A conventional scoop and measuring cup, as they are pre-formed into their volume-capturing configuration, are not easily packaged for shipment and storage in association with the product container. A common solution is to add the scoop or measuring cup into the material-containing-volume of the container after it has been filled with the product. The container is then shipped and stored with the scoop or measuring cup inside. During shipment it is common for the scoop or measuring cup to become buried within the product. A user is required to “fish” within the container to locate and retrieve the scoop or measuring cup. Depending upon the dimensions of the container this may not be a trivial task, particularly when the scoop or measuring cup is deeply buried.

This is problematic on several fronts. In some cases users are discouraged when they cannot locate the scoop or measuring cup. In some cases the user may believe that the container was shipped without the scoop or measuring cup. This belief, even in cases when the scoop or measuring cup is present, can lead to complaints and mistaken criticisms of the product and manufacturer/distributor.

Further, for some types of product, e.g., infant formula, the user does not desire to use a foreign object to search the container volume for the scoop or measuring cup. For these users, the unavailability of the scoop or measuring cup in a convenient and sanitary manner is unacceptable.

What is needed is a system and method for a constructible scoop that overcomes the disadvantages of conventional preformed scoops that are shipped in association with a scoopable product.

### BRIEF SUMMARY OF THE INVENTION

Disclosed is a system and method for a constructible scoop that overcomes the disadvantages of conventional preformed scoops that are shipped in association with a scoopable product.

The following summary of the invention is provided to facilitate an understanding of some of technical features related to constructible scoops and measuring cups, and is not intended to be a full description of the present invention. A full appreciation of the various aspects of the invention can be gained by taking the entire specification, claims, drawings, and abstract as a whole. The present invention is applicable to other product format types and product delivery mechanisms.

Embodiments of the present invention address short-comings of conventional solutions for shipping a “scoop” with a container of scoopable material. The constructible scoop may be affixed to the outside of the container, sealed in a sanitary covering, disposed under a lid, or otherwise affixed to the shipping format without being placed loose and/or exposed within the product-containing volume of the container. Thus the scoop will not become buried and lost or difficult to retrieve. The constructible scoop may be made from environmentally-friendly materials, and in some implementations it may be made compostable in compliance with current compostable standards.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a pre-constructed constructible scoop;

FIG. 2 illustrates a constructed format for the scoop of FIG. 1;

FIG. 3 illustrates a first alternative pre-constructed constructible scoop;

FIG. 4 illustrates a constructed format for the scoop of FIG. 3;

FIG. 5 illustrates a second alternative pre-constructed constructible scoop; and

FIG. 6 illustrates a constructed format for the scoop of FIG. 5.

### DETAILED DESCRIPTION OF THE INVENTION

Embodiments of the present invention provide a system and method for a constructible scoop that overcomes the disadvantages of conventional preformed scoops that are shipped in association with a scoopable product. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

The embodiments described herein preferably use an environmentally-friendly planar stock (and most preferably being compostable planar stock) having a thickness appropriate to the application. Appropriateness is measured by the material of the stock (e.g., a paperboard stock, a mineral composite, or the like) that may be folded and scored. It cannot be too thin or too thick. If it is too thin it cannot function effectively as a scoop and if it is too thick it is difficult to fold/bend without degradation/damage/fracture. Foldable paperboard stock (e.g., folding boxboard, 16 point cold cup stock, and the like) greater than 10 point, single or multi-ply, or its equivalent, is preferably used in the disclosed embodiments though other stock may be used.

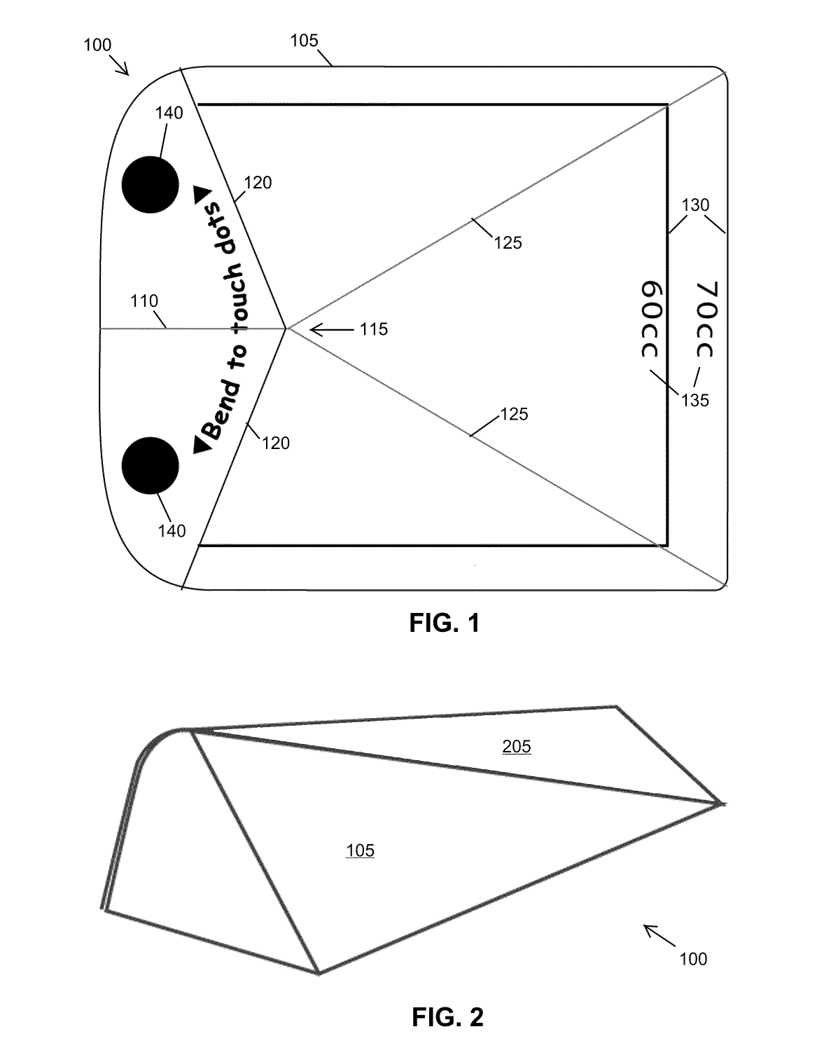

FIG. 1 illustrates a pre-constructed constructible scoop 100 and FIG. 2 illustrates a constructed format for constructible scoop 100. Constructible scoop 100 includes a body 105 that is planar and deformable (e.g., bendable, foldable, and/or otherwise transformable) made from a suitable planar stock. Body 105 includes a handle portion joined to a scoop portion, and a plurality of scores defining these body portions and aiding in formation of a handle from the handle portion and a scoop at the scoop portion when constructed. Body 105 is generally rectilinear having a length greater than a width. Corners are rounded to avoid sharp corners with corners for the handle portion having a greater radius of curvature to better facilitate easy gripping without encountering an uncomfortable protruding edge.

The plurality of scores include a longitudinal score 110 extending from a rear lateral edge of the handle portion to a vertex 115. Longitudinal score 110 extends lengthwise along a longitudinal axis that divides body 105 into two generally symmetric halves.

The plurality of scores also include a pair of handle scores 120 and a pair of scoop scores 125 that each extend from vertex 115 to an edge of body 105. Handle scores 120 form an angle less than ninety degrees with respect to longitudinal score 110 and extend back towards the rounded corners of the handle portion while scoop scores 125 form an angle greater than ninety degrees with respect to longitudinal score 110 and extend forward towards the rounded corners of the scoop portion. The particular angular relationships formed by these scores are related to the length and width of body 105 as well as the placement of vertex 115 along the longitudinal axis. The length and width and placement of vertex 115 affect the defined volume of the constructed scoop made from constructible scoop 100. Note that the indicated score pattern is not necessarily reflective of which side of body 105 supports any given score. For example, different implementations may provide for any particular score to fold upwardly or downwardly (as seen from a top view such as FIG. 1). And in some cases, irrespective of which “direction” any particular score folds, bends, or transforms, a score, deboss, pattern, or the like may be on either side of body 105. (That is, it is not necessary that a “top” score requires that body 105 must fold either particular direction, but any given implementation typically has a preference for fold directions of the score patterns as implemented in order to produce a desired configuration for the constructed utensil or implement or device.

In addition to the plurality of scores, body 105 is preferably provided with one or more optional volume indicators 130 and/or corresponding volumetric labels 135 for a closed volume 205 (closed in this context means closed at the bottom and sides with a top opening). Volume indicators 130 provide a user with a visual calibration (which may be approximate) of a volume of material disposed in the scoop of a constructed scoop as shown in FIG. 2 when the material fills the scoop portion to any particular indicator 130. As noted, a top lateral edge of the scoop portion may be one such indicator 130.

The handle portion also includes a pair of construction indicia 140 (e.g., the pair of “bend to touch dots”). These indicia visually guide the user on how to manipulate body 105 to construct the scoop. The indicated action, in cooperation with the arrangement of the plurality of scores, initiates the constructing action to produce the final result. Note that “bend to touch” may in some instances be an indication to touch a “backside” of the dots together, such as when longitudinal score 110 lifts relative to the lateral edges so the lateral edges move below longitudinal score 110. Formation of the score pattern and particularly longitudinal score 110 to have a predisposition to folding in an appropriate and particular direction aids in any disambiguation as to which side of the dots are to be touched.

In operation, body 105 is manipulated by bending, folding, and the like about the score pattern in order to touch the backsides of construction indicia 140. This action propagates bending, folding, and transformation forces along the score pattern so that vertex 115 “sinks” relative to the lateral edges to form closed volume 205. The scoop is completely constructed when the dots are touched, however a partially constructed scoop may be useful in some contexts. The user grips the handle (formed from the handle portion) and operates the scoop to capture a desired quantity of material within closed volume 205.

In some embodiments, a tacky adhesive or other connection mechanism may be disposed on the backsides of the dots to maintain the scoop in the constructed mode. The connection mechanism may be temporary allowing for deconstruction and flattening or permanent to maintain the scoop in the constructed mode between uses and after the user releases the handle portion.

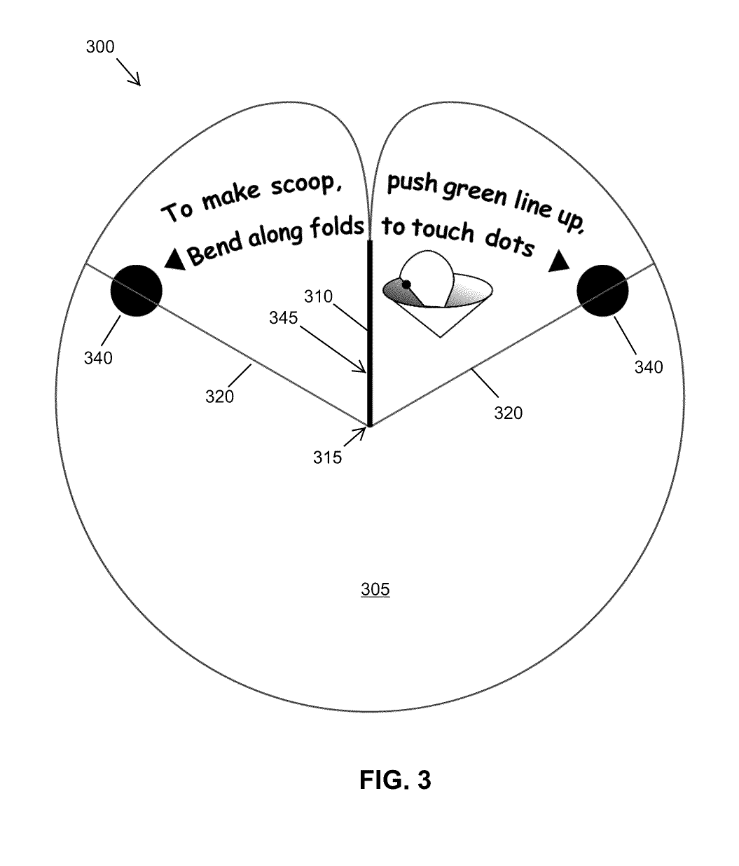

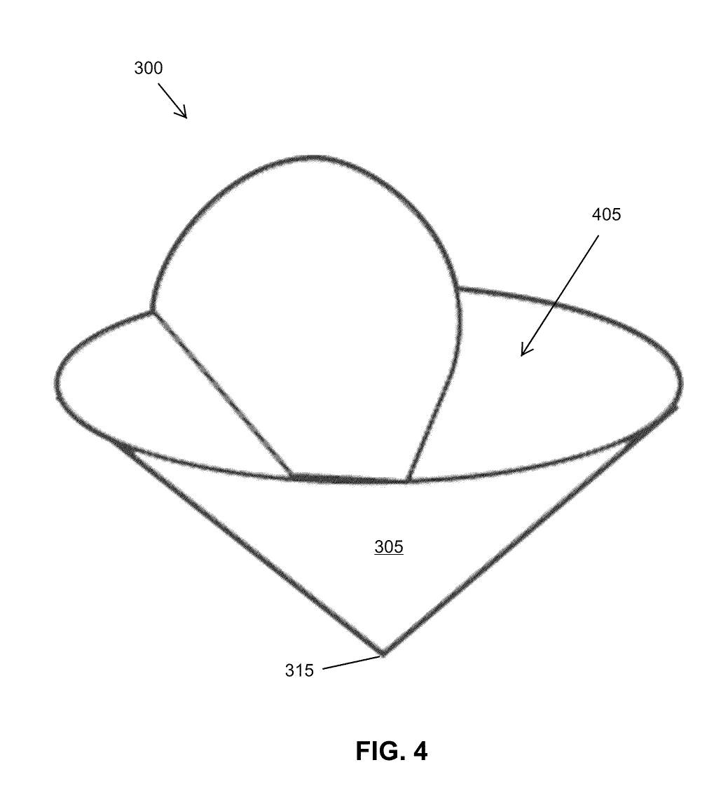

FIG. 3 illustrates a first alternative pre-constructed constructible scoop 300, and FIG. 4 illustrates a constructed format for the scoop of FIG. 3. Constructible scoop 300 includes a body 305 that is planar and deformable (e.g., bendable, foldable, and/or otherwise transformable) made from a suitable planar stock. Body 305 includes a handle portion joined to a scoop portion, and a plurality of scores defining the portions and aiding in formation of a handle from the handle portion and a scoop at the scoop portion when constructed. Body 305 is generally circular though some embodiments may be elliptical or ovoid or the like.

The plurality of scores include a diameterial score 310 extending from a rear edge of the handle portion to a vertex 315. Diameterial score 310 extends along a diameter that divides body 305 into two generally symmetric halves. For other shapes score 310 will not be a diameter but some other line with symmetry (e.g., a major or minor axis of an elliptical format).

The plurality of scores also include a pair of handle scores 220 that each extend from vertex 315 to an edge of body 305. Handle scores 320 form an angle less than ninety degrees with respect to diameterial score 310. The particular angle formed by these scores is related to the radius and/or length and width of body 305 as well as the placement of vertex 315 along the longitudinal axis. The length and width and placement of vertex 315 affect the defined volume of the constructed scoop made from constructible scoop 300. Note that the indicated score pattern is not necessarily reflective of which side of body 305 supports any given score. For example, different implementations may provide for any particular score to fold upwardly or downwardly (as seen from a top view such as FIG. 3). And in some cases, irrespective of which “direction” any particular score folds, bends, or transforms, a score, deboss, pattern, or the like may be on either side of body 305. (That is, it is not necessary that a “top” score requires that body 305 must fold either particular direction, but any given implementation typically has a preference for fold directions of the score patterns as implemented in order to produce a desired configuration for the constructed utensil or implement or device.

In addition to the plurality of scores, body 305 is preferably provided with one or more optional volume indicators and/or corresponding volumetric labels for a closed volume 405 (closed in this context means closed at the bottom and sides with a top opening). Volume indicators provide a user with a visual calibration (which may be approximate) of a volume of material disposed in the scoop of a constructed scoop as shown in FIG. 4 when the material fills the scoop portion to any particular indicator. A top lateral edge of the scoop portion may be one such indicator.

The handle portion also includes a pair of construction indicia 340 (e.g., the pair of “bend to touch dots”) and a colored score identifier 345. These indicia visually guide the user on how to manipulate body 305 to construct the scoop. The indicated action, in cooperation with the arrangement of the plurality of scores, initiates the constructing action to produce the final result. Note that “bend to touch” may in some instances be an indication to touch a “backside” of the dots together, such as when score 310 lifts relative to the lateral edges so the lateral edges move below score 310. Formation of the score pattern and particularly longitudinal score 310 to have a predisposition to folding in an appropriate and particular direction aids in any disambiguation as to which side of the dots are to be touched. In some cases, additional instructions may be useful and/or necessary to indicate to a user how to manipulate body 305. For example, the instruction text refers to a “green line” which references colored (e.g., “green”—though any distinguishing color or pattern may be used) score identifier 345. In this case, score 310, identified by colored score indicator 345, is pushed “up” to bring back sides of construction indicia 340 into contact.

In operation, body 305 is manipulated by bending, folding, and the like about the score pattern in order to touch the backsides of construction indicia 340. This action propagates bending, folding, and transformation forces along the score pattern so that vertex 315 “sinks” relative to the lateral edges to form closed volume 405. The scoop is completely constructed when the dots are touched, however a partially constructed scoop may be useful in some contexts. The user grips the handle (formed from the handle portion) and operates the scoop to capture a desired quantity of material within closed volume 405.

In some embodiments, a tacky adhesive or other connection mechanism may be disposed on the backsides of the dots to maintain the scoop in the constructed mode. The connection mechanism may be temporary allowing for deconstruction and flattening or permanent to maintain the scoop in the constructed mode between uses and after the user releases the handle portion.

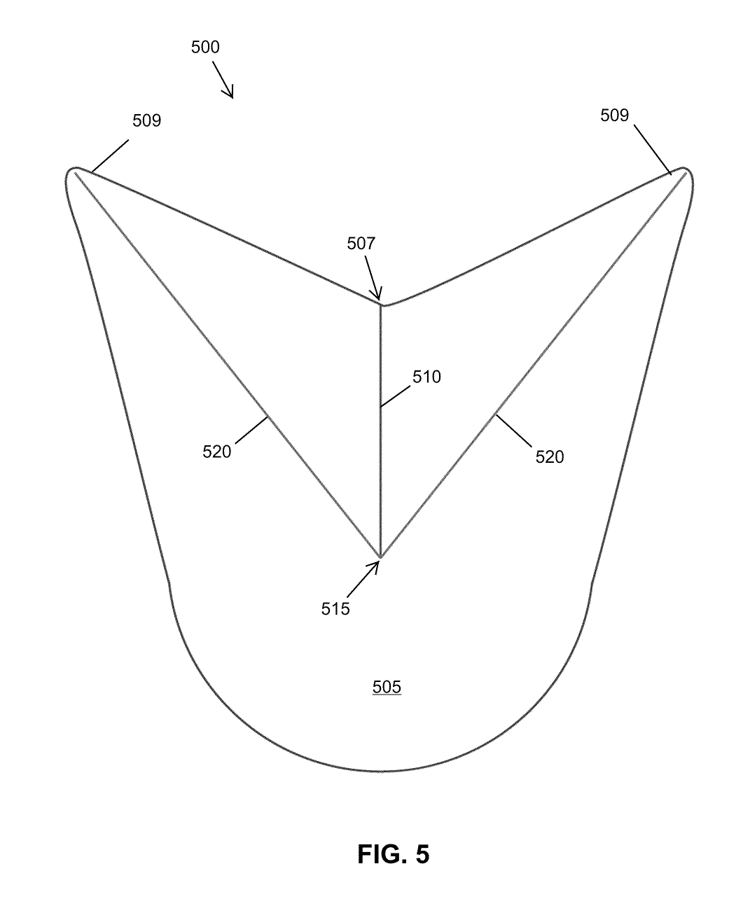

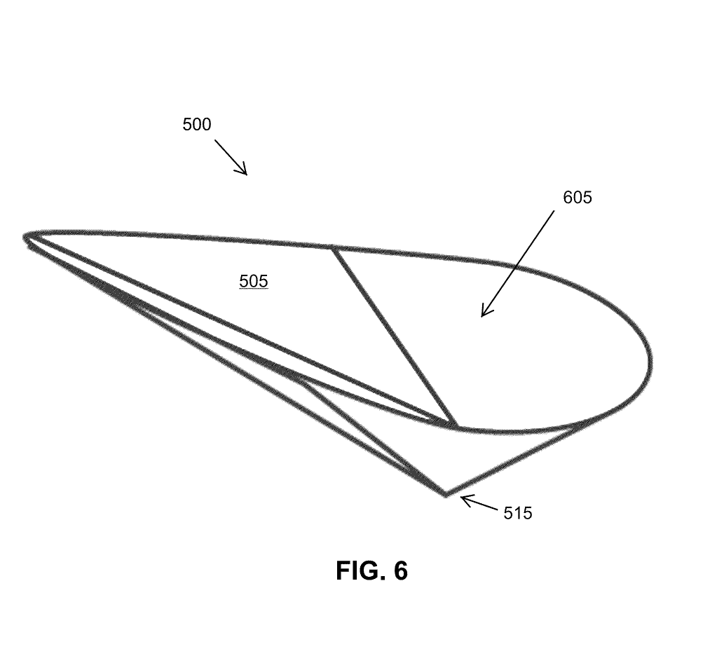

FIG. 5 illustrates a second alternative pre-constructed constructible scoop 500 and FIG. 6 illustrates a constructed format for constructible scoop 500 of FIG. 5. Constructible scoop 500 includes a body 505 that is planar and deformable (e.g., bendable, foldable, and/or otherwise transformable) made from a suitable planar stock. Body 505 includes a handle portion joined to a scoop portion, and a plurality of scores defining the portions and aiding in formation of a handle from the handle portion and a scoop at the scoop portion when constructed. Body 505 includes a complex perimeter shaped including a rounded (some cases circular) proximal end joined to a middle portion including diverging lateral edges extending to a distal end. A rear edge is “notched” with a notch point 507 at a longitudinal axis of body 505, notch point 507 creating a pair of diverging pointed handle elements 509.

The plurality of scores include a longitudinal score 510 extending from notch point 507 of the handle portion to a vertex 515. Longitudinal score 510 extends along the longitudinal axis that divides body 505 into two generally symmetric halves.

The plurality of scores also include a pair of handle scores 520 that each extend from vertex 515 to a tip of handle element 509. Handle scores 520 form an angle less than ninety degrees with respect to longitudinal score 510. The particular angle formed by these scores is related to the length and width of body 505 as well as the placement of vertex 515 along the longitudinal axis. The length and width and placement of vertex 515 affect the defined volume of the constructed scoop made from constructible scoop 500. Note that the indicated score pattern is not necessarily reflective of which side of body 305 supports any given score. For example, different implementations may provide for any particular score to fold upwardly or downwardly (as seen from a top view such as FIG. 5). And in some cases, irrespective of which “direction” any particular score folds, bends, or transforms, a score, deboss, pattern, or the like may be on either side of body 505. (That is, it is not necessary that a “top” score requires that body 505 must fold either particular direction, but any given implementation typically has a preference for fold directions of the score patterns as implemented in order to produce a desired configuration for the constructed utensil or implement or device.

In addition to the plurality of scores, body 505 may be preferably provided with one or more optional volume indicators and/or corresponding volumetric labels for a closed volume 605 (closed in this context means closed at the bottom and sides with a top opening). Volume indicators provide a user with a visual calibration (which may be approximate) of a volume of material disposed in the scoop of a constructed scoop as shown in FIG. 6 when the material fills the scoop portion to any particular indicator. A top lateral edge of the scoop portion may be one such indicator.

The handle portion may also include a pair of construction indicia (e.g., the pair of “bend to touch dots” as elsewhere described) and/or a colored score identifier. These indicia and identifiers visually guide the user on how to manipulate body 505 to construct the scoop. The indicated action, in cooperation with the arrangement of the plurality of scores, initiates the constructing action to produce the final result. Note that “bend to touch” may in some instances be an indication to touch a “backside” of the dots together, such as when longitudinal score 510 lifts relative to the lateral edges so the lateral edges move below longitudinal score 510. Formation of the score pattern and particularly longitudinal score 510 to have a predisposition to folding in an appropriate and particular direction aids in any disambiguation as to which side of the dots are to be touched. In some cases, additional instructions may be useful and/or necessary to indicate to a user how to manipulate body 505. For example, the instruction text may refers to a “green line” which references a colored (e.g., “green”—though any distinguishing color or pattern may be used) score identifier. For example, longitudinal score 510 could be identified by the colored score indicator, is pushed “down” to bring front sides of any construction indicia into contact.

In operation, body 505 is manipulated by bending, folding, and the like about the score pattern in order to touch the front sides of any construction indicia. This action propagates bending, folding, and transformation forces along the score pattern so that vertex 515 “sinks” relative to the lateral edges to form closed volume 605. The scoop is completely constructed when the dots are touched, however a partially constructed scoop may be useful in some contexts. The user grips the handle (formed from the handle portion) and operates the scoop to capture a desired quantity of material within closed volume 605.

In some embodiments, a tacky adhesive or other connection mechanism may be disposed on the backsides of the dots to maintain the scoop in the constructed mode. The connection mechanism may be temporary allowing for deconstruction and flattening or permanent to maintain the scoop in the constructed mode between uses and after the user releases the handle portion.

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. The apparatus substantially as disclosed herein.

2. The method substantially as disclosed herein.
